(19) United States
(12) Patent Application Publication
(10) Pub. No.: US 2026/0301581 A1
(43) Pub. Date: Oct. 1, 2026

(54) SYSTEMS AND METHODS FOR EVALUATING PROCEDURES FOR ENVISIONED AIR MOBILITY OPERATIONS

(71) Applicant: Ohio State Innovation Foundation, Columbus, OH (US)

(72) Inventor: Martijn IJTSMA, Columbus, OH (US)

(21) Appl. No.: 19/479,898

(22) PCT Filed: May 1, 2024
(86) PCT No.: PCT/US2024/027213

§ 371 Date: Oct. 29, 2025

Related U.S. Application Data
(60) Provisional application No. 63/463,143, filed on May 1, 2023.

(51) Int. Cl. G08G 5/30; G05D 1/698; G05D 109/20; G08G 5/72

(52) U.S. Cl. CPC G08G 5/30; G05D 1/6987; G08G 5/72; G05D 2109/20

(57) ABSTRACT

Example methods of modeling traffic are described herein. An example method for modeling traffic includes obtaining a dynamic model of a traffic management process; simulating a scenario based on the traffic management process; and measuring a resource usage of the scenario.

### CROSS-REFERENCE TO RELATED APPLICATIONS

This application claims the benefit of U.S. provisional patent application No. 63/463,143 filed on May 1, 2023, and titled “SYSTEMS AND METHODS FOR EVALUATING PROCEDURES FOR ENVISIONED AIR MOBILITY OPERATIONS,” the disclosure of which is expressly incorporated herein by reference in its entirety.

### STATEMENT REGARDING FEDERALLY FUNDED RESEARCH

This invention was made with government support under 80NSSC22PB098 awarded by the National Aeronautics and Space Administration. The government has certain rights in the invention.

### BACKGROUND

Traffic management is the process of coordinating the movements of aerial vehicles. Aerial vehicles commonly include both crewed vehicles (e.g., planes, helicopters) and uncrewed vehicles (e.g., unmanned aerial systems like drones). Aerial vehicles commonly perform a wide range of mission types, including carrying cargo and passengers, remote sensing, and recreation. Aerial vehicles often share airspace, risking collision. For example, airspaces can be divided by their level of congestion, proximity to urban centers, and/or altitude. Communication and coordination between various aerial vehicles can be used to avoid collisions and allow each aerial vehicle to successfully complete its mission as it moves within and between different airspaces. There are benefits to improving traffic management of aerial vehicles, including traffic management.

### SUMMARY

In some aspects, the techniques described herein relate to a method for modeling traffic management, including: obtaining a dynamic model of a traffic management process; simulating a scenario based on the traffic management process; and measuring a cost of the scenario.

In some aspects, the techniques described herein relate to a method, wherein the cost includes communication overhead.

In some aspects, the techniques described herein relate to a method, wherein the method further includes outputting feedback to a user based on dynamically evaluating alternative traffic management processes based on the cost of the scenario.

In some aspects, the techniques described herein relate to a method, wherein the cost includes a coordination overhead.

In some aspects, the techniques described herein relate to a method, wherein the scenario includes a model of an uncrewed aerial vehicle (UAV).

In some aspects, the techniques described herein relate to a method, wherein the scenario includes a model of a crewed aerial vehicle (UAV).

In some aspects, the techniques described herein relate to a method, wherein the scenario includes a model of a vertical take-off and landing aircraft (VTOL).

In some aspects, the techniques described herein relate to a method, wherein the scenario includes a model of an electric vertical take-off and landing aircraft (eVTOL).

In some aspects, the techniques described herein relate to a method, wherein the scenario includes a model of an electric vertical take-off and landing aircraft (eVTOL).

In some aspects, the techniques described herein relate to a method, wherein the scenario includes a model of low-altitude air operations.

In some aspects, the techniques described herein relate to a method, wherein the scenario includes a model of shorter range air operations.

In some aspects, the techniques described herein relate to a method, wherein the scenario includes a simulated event.

In some aspects, the techniques described herein relate to a method, wherein the method further includes measuring a cost of the simulated event in the scenario.

In some aspects, the techniques described herein relate to a method, wherein the simulated event includes an emergency.

In some aspects, the techniques described herein relate to a method, wherein the simulated event includes a contingency.

In some aspects, the techniques described herein relate to a method, wherein the traffic management process includes a procedure for an airspace operator.

In some aspects, the techniques described herein relate to a method, further including evaluating the traffic management process based on the cost of the scenario.

In some aspects, the techniques described herein relate to a method, wherein the scenario includes a re-routing event.

In some aspects, the techniques described herein relate to a method, wherein the scenario includes a plurality of agents.

In some aspects, the techniques described herein relate to a method, wherein the plurality of agents includes a plurality of models of aerial vehicles.

In some aspects, the present disclosure relates to a system for traffic management of uncrewed aerial vehicles including a plurality of uncrewed aerial systems; and a controller in operable communication with the plurality of uncrewed aerial vehicles, where the controller includes a processor and a memory, the memory having computer-executable instructions stored thereon that, when executed by the processor, cause the processor to: obtain a scenario, where the scenario includes traffic management information for a plurality of uncrewed aerial vehicles; obtain a dynamic model of a traffic management process; simulate the scenario based on the traffic management process; measure a resource usage of the scenario; and control the plurality of uncrewed aerial vehicles based on the resource usage of the scenario.

In some aspects, the memory has further computer executable instructions stored thereon that, when executed by the processor, cause the processor to: dynamically evaluate a plurality of alternative traffic management processes based on the resource usage of the scenario.

In some aspects, the system further includes a user interface operably coupled to the controller, where the user interface is configured to provide feedback to a user based on dynamically evaluating the plurality of traffic alternative traffic management processes based on the resource usage of the scenario.

In some aspects, the scenario further includes a simulated event, and where the memory has further computer executable instructions stored thereon that, when executed by the processor, cause the processor to: estimate a resource usage of the simulated event in the scenario.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 illustrates a method of measuring a cost of a simulated scenario, according to implementations of the present disclosure.

FIG. 2 illustrates a Work Models that Compute (WMC) framework for modeling agent, actions, and resources, according to implementations of the present disclosure.

FIG. 3A illustrates an example relationship between subjective resources, information resources, actions and agents, according to implementations of the present disclosure.

FIG. 3B illustrates an agent performing action1 checks for information currency before getting IR2, if the currency has expired IR2 is updated and then used., according to implementations of the present disclosure.

FIG. 4 illustrates effects of information currency requirements and update time of information on agents that own or request the information, according to implementations of the present disclosure.

FIG. 5A illustrates an example system for controlling UAS's, according to implementations of the present disclosure.

FIG. 5B illustrates agents in an example uncrewed air traffic management system, according to implementations of the present disclosure.

FIG. 6 illustrates an example traffic scenario, according to implementations of the present disclosure.

FIGS. 7A-7B illustrate results from a simulation, according to implementations of the present disclosure, where: FIG. 7A shows the altitudes of the vehicles and FIG. 7B shows a trace of when actions are performed by each agent.

FIG. 8 illustrates four communications strategies plotted over time, according to implementations of the present disclosure.

FIG. 9 illustrates coordination load per agent, according to implementations of the present disclosure.

FIG. 10 illustrates a table of description of actions and their timing strategies, according to implementations of the present disclosure.

FIG. 11 illustrates values for the independent measures of required information currency and information push interval, according to implementations of the present disclosure.

FIG. 12 is an example computing device.

FIG. 13 illustrates a shaded plot of total communication taskload (number of actions) for all agents and entire scenario where shading represents higher communication taskload, according to a study of an example implementation of the present disclosure.

FIGS. 14A-14C illustrates total communications taskload per agent where shading represents higher communication taskload, according to a study of an example implementation of the present disclosure. FIG. 14A illustrates communication taskload for an example service provider. FIG. 14B illustrates communication taskload for a first example RPIC (remote Pilot in Command). FIG. 14C illustrates communication taskload for a second example RPIC.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not. Ranges may be expressed herein as from “about” one particular value, and/or to “about” another particular value. When such a range is expressed, an aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. While implementations will be described for modeling air traffic, it will become evident to those skilled in the art that the implementations are not limited thereto, but are applicable for modeling other types of traffic and traffic management (e.g., watercraft, ground vehicles, etc.).

The term “artificial intelligence” is defined herein to include any technique that enables one or more computing devices or comping systems (i.e., a machine) to mimic human intelligence. Artificial intelligence (AI) includes, but is not limited to, knowledge bases, machine learning, representation learning, and deep learning. The term “machine learning” is defined herein to be a subset of Al that enables a machine to acquire knowledge by extracting patterns from raw data. Machine learning techniques include, but are not limited to, logistic regression, support vector machines (SVMs), decision trees, Naïve Bayes classifiers, and artificial neural networks. The term “representation learning” is defined herein to be a subset of machine learning that enables a machine to automatically discover representations needed for feature detection, prediction, or classification from raw data. Representation learning techniques include, but are not limited to, autoencoders. The term “deep learning” is defined herein to be a subset of machine learning that enables a machine to automatically discover representations needed for feature detection, prediction, classification, etc. using layers of processing. Deep learning techniques include, but are not limited to, artificial neural network or multilayer perceptron (MLP).

Machine learning models include supervised, semi-supervised, and unsupervised learning models. In a supervised learning model, the model learns a function that maps an input (also known as feature or features) to an output (also known as target or targets) during training with a labeled data set (or dataset). In an unsupervised learning model, the model learns patterns (e.g., structure, distribution, etc.) within an unlabeled data set. In a semi-supervised model, the model learns a function that maps an input (also known as feature or features) to an output (also known as target or targets) during training with both labeled and unlabeled data.

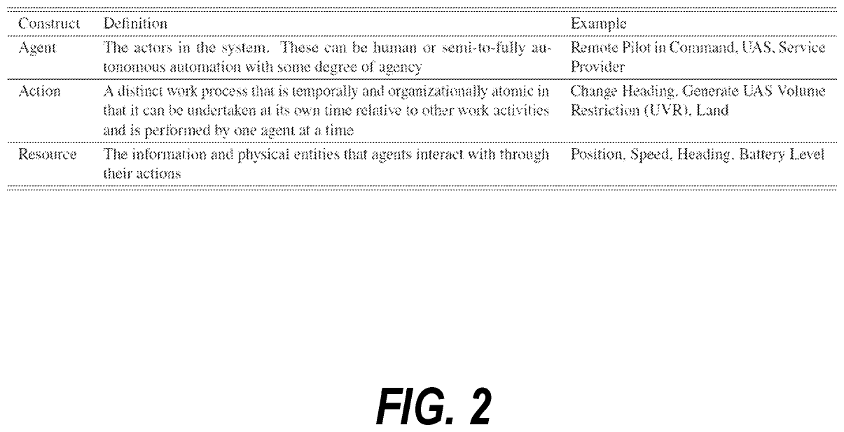

Described herein are systems and related methods for simulating air traffic and air traffic management, including for low altitude (“low altitude airspace”) and/or short range air operations of uncrewed aerial vehicles (UAVs). Non-limiting examples of systems for low altitude and/or shorter range air operations include systems and methods for Uncrewed Air Traffic Management (UTM) and Advanced Air Mobility (AAM) operations.. As described in the Example, the systems and methods can include systems and methods for comparing different air traffic management schemes. Performing simulations of low altitude and/or short range air operations (e.g., UTM/AAM systems and operations) can be used to evaluate different traffic management processes, and evaluate the cost of scenarios including those traffic management processes. By simulating the traffic in low altitude airspace and/or short range operations, systems and operations including UAVs, costly real-world simulations can be minimized, saving time and other costs. FIG. 2 illustrates a Work Models that Compute (WMC) framework for modeling agent, actions, and resources that can be applied to UAVs according to implementations of the present disclosure.

WMC is a modeling and simulation framework that focuses specifically on evaluating situated work in multi-agent systems [30, 34]. Situated work refers to activity that is closely coupled with the environment, in that it acts upon and responds to the situation at hand. Unlike cognitive architectures, WMC can use simple agent models but more elaborate models of the work environment (e.g., dynamic processes, such as aircraft dynamics in air transportation) and the work functions (e.g., how and when they act on those processes). As such, WMC can be used to identify emergent patterns of behavior that are determined by characteristics inherent to the interaction between activity and the work environment. To better analyze and control air operations, the communication demands in air operations can be modeled and analyzed by implementations of the present disclosure. Communication demands of air operations are referred to herein as “communication overhead” and its manifestation through time as driven by the dynamics of the traffic situation and the system architecture. WMC is particularly suited for this problem as it allows explicit modeling of the interaction between aircraft dynamics and the timing of communication strategies.

In some implementations, the systems and methods can explicitly account for the costs of coordination, in terms of the temporal and cognitive overhead that is involved in sharing information. This affords the evaluation of a range of possible strategies that system design might need to support to enable robust and resilient performance.

It should be understood that the implementations of the present disclosure can also be used for applications other than short-range and/or low-altitude operations. For example, other implementations of the present disclosure can be used for analyzing distributed systems in safety-critical domains such as defense, space operations, and disaster response.

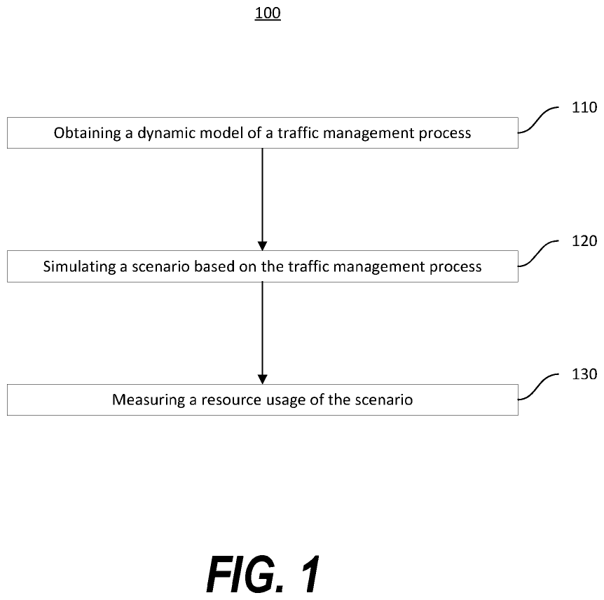

FIG. 1 illustrates a flowchart of an example method 100 for modeling traffic management.

At step 110, the method includes obtaining a dynamic model of a traffic management process. As a non-limiting example, the traffic management process can include a procedure for an airspace operator.

At step 120, the method further includes simulating a scenario based on the traffic management process. The scenario can optionally include a plurality of agents. In some implementations, the plurality of agents can included a plurality of models of aerial vehicles including crewed and uncrewed aerial vehicles.

Optionally, the scenario can include any or all of: a model of an uncrewed aerial vehicle (UAV); a model of a crewed aerial vehicle; a model of uncrewed traffic management (UTM); a model of crewed traffic management; a model of urban air mobility; a model of low altitude airspace; a model of short range air operations; and/or a simulated event. As a non-limiting example, the simulated event can be an emergency or contingency in some implementations of the present disclosure. As used herein, the term “urban air mobility” can refer to operations below about 3,000 feet in urban areas. As used herein, uncrewed aerial system traffic management can refer to traffic services for small UAS, below about 400 feet, for example.

Alternatively or additionally, the scenario can include a re-routing event.

At step 130, the method further includes measuring a resource usage of the scenario. As used herein, resource usage includes communication overhead, where communication overhead can include time and/or resources that are incurred by exchanging information for traffic management. Communication overhead can optionally include measures of the human time spent in communication, as well as the system overhead used for communication. Non-limiting examples of communication overhead include exchanging status, intent, and/or managing handoffs between different controllers (both human and automated controllers). Alternatively or additionally, the resource usage can include a communication cost and/or a coordination cost. In some implementations, the method can further include outputting feedback to a user based on dynamically evaluating alternative traffic management processes based on the resource usage of the scenario. In implementations including simulated events, the scenario can include measuring the resource usage of the simulated event.

In some implementations, the traffic management process can be evaluated based on the cost of the scenario.

Embodiments of the present disclosure include systems for implementing traffic management, for example traffic management among uncrewed aerial vehicles. The systems described herein can be configured to implement any of the methods described with reference to FIG. 1.

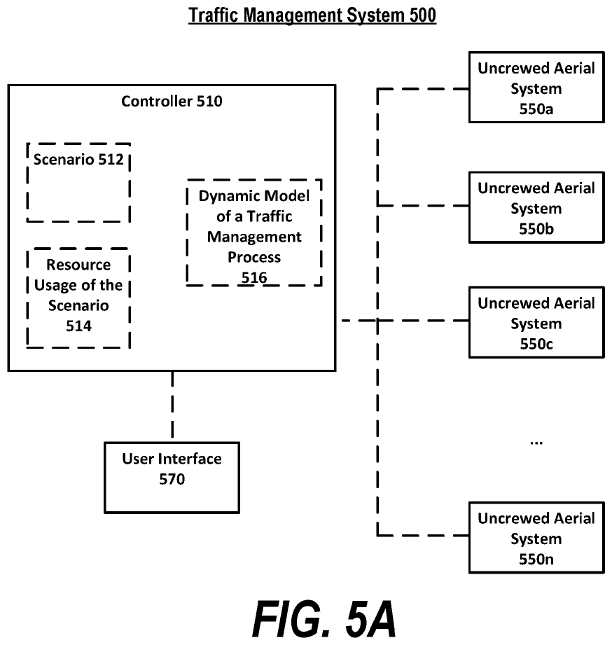

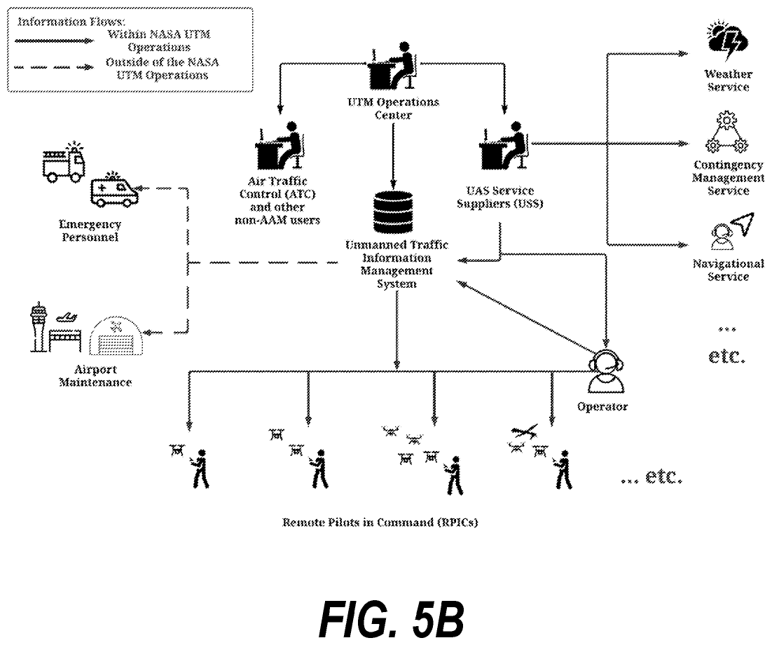

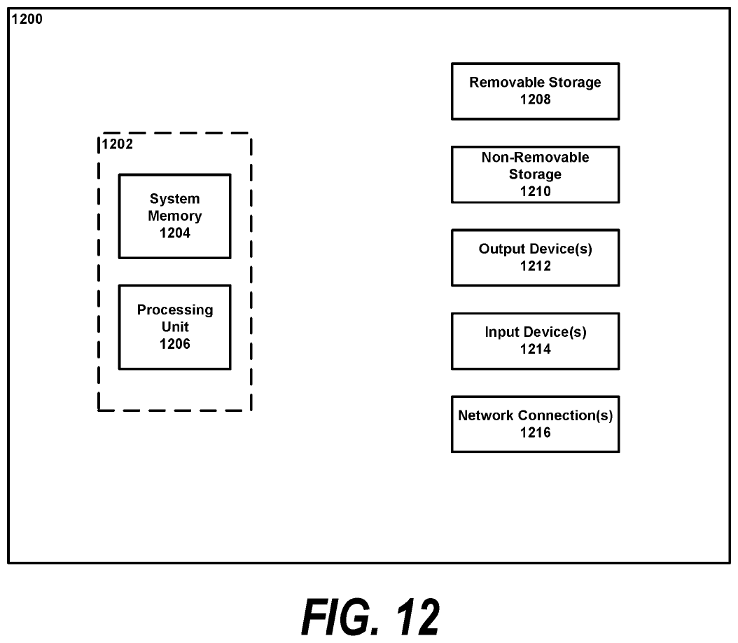

An example system 500 is shown in FIG. 5A, according to implementations of the present disclosure. The system 500 can include any number of UAS's shown as 550a, 550b, 550c . . . 550n. The UAS's are in operable communication with a controller 510. The present disclosure contemplates that the controller 510 can include a computing device (e.g., any or all of the components shown in the computing device 1200 of FIG. 12.

The controller 510 can obtain a scenario 512. The scenario 512 can include traffic management information. Optionally the traffic management information includes the status of any or all of the UAS's 550a-550n, as well as sensor data from other sensors (e.g., RADAR). The scenario 512 can further include information about various emergency conditions or exceptions that have occurred that affect the operation of the UAS's 550a-550n.

The controller 510 can further obtain a dynamic model of a traffic management process 516. The dynamic model of the traffic management process 516 includes a model of the resource usage of different traffic management processes. As described with reference to FIG. 1, different traffic management processes can impose different amounts of cognitive and communication load on uncrewed aerial systems 550a-550n, as well as human controllers of those UASs (if any).

The controller 510 can simulate the scenario 512 based on the dynamic model of the traffic management process 516. Based on the simulated scenario 512, the controller 510 can measure a resource usage of the scenario 514.

The resource usage of the scenario 514 can be used to determine how to control the UAS's 550a-550n. For example dynamic models of multiple different traffic management processes can be measured to determine which traffic management process has the lowest resource usage of the scenario 514, and the controller 510 can then control the UAS's 550a-550n based on the traffic management process with the lowest resource usage of the scenario 514.

In some implementations, the system 500 can further include a user interface 570 operably coupled to the controller. The user interface 570 can be configured to provide feedback to a user based on dynamically evaluating the plurality of traffic alternative traffic management processes based on the resource usage of the scenario 512 executed using models of traffic management processes.

In some implementations, the scenario 512 can include a simulated event, as described with reference to FIG. 1. The controller 510 can optionally estimate a resource usage of the event. Alternatively or additionally, the resource usage of the simulated event can be output by the system 500, for example using the user interface 570.

### EXAMPLE

Example implementations of the present disclosure were implemented and tested in a study.

The example implementations can be used for short range and/or low altitude operations, including using uncrewed aerial vehicles (UAVs) (e.g., Advanced Air Mobility (AAM) operations) that can require support for interdependent parties, including pilots, fleet operators, and airspace managers, to safely and efficiently coordinate and manage shared airspace. Timely and quality communication is key to maintaining common ground between different roles, especially when dynamically cascading events required high-tempo responses. To assure that communication is adequately supported in the design of procedures and aids, embodiments of the present disclosure include development of the operational concepts for UAV control that can account for communication overhead and consider strategies for distributing this overhead among the AAM actors. This study draws from research on team cognition and communication to develop a multi-agent model of the work involved in communication. The model quantifies the temporal and cognitive overhead associated with communication and to dynamically evaluate alternate communication strategies. The example described herein includes a study of contingency management in Uncrewed Air Traffic Management (UTM) to demonstrate how implementations of the present disclosure can enable analysis of a range of alternate strategies.

The example implementation studied can take existing models of communication strategies that are based on empirical studies and translate them into a dynamic model that can simulate communication demands in envisioned AAM operations. The focus is on simulating collaborative work in AAM to (1) identify how interdependencies between agents create communication demands and (2) how temporal and cognitive overhead of communication can be managed through alternative information-sharing strategies. To analyze the temporal and cognitive demands of communication, the proposed dynamic model is based on the conceptual model of communication and coordination by Entin [17]. WMC is used as the modeling and simulation framework. WMC has three main elements: actions, agents, and resources [26]. An action represents a distinct work process that is temporally and organizationally atomic in that it can be undertaken at its own time relative to other work activities and is undertaken by one agent at a time. There are two types of actions: temporal actions and decision actions. Temporal actions represent the actions that interact with the environment, simulating how work both responds to and manipulates the work environment. Decision actions represent activity associated with reconfiguring the work system, such as selecting a strategy from a range of options. For example, a decision action might simulate the selection of a procedure to respond to a contingency based on the current status of the controlled system.

Resources are the information and physical entities that agents interact with. Information resources capture the state of the work environment as elemental values (e.g., the altitude, speed, and heading of a vehicle can be modeled as three information resources). Information needs are accounted for by modeling what information resources each action needs as input, and what information resources it manipulates as its output.

Agents represent the actors in the system and can be human or semi-to-fully autonomous automation with some degree of agency. Actions can be allocated to agents, who then execute actions. The allocation of actions to agents provides a mechanism for modeling and evaluating alternative system architectures, in terms of what actors are involved and what role each has in the system's operation.

WMC can evaluate the dynamic effects of interactions between the three elements through computational simulation.

A simulation run involves sorting actions by when they need to be executed relative to dynamic processes in the work environment, such as vehicle dynamics. The framework dynamically updates actions, calling agent models when actions are due for execution while also scheduling new actions based on the current and projected state of the work environment.

WMC can be used to identify what the communication and coordination demands are based on constraints in the work and the system architecture. Based on how actions are allocated to agents, and how actions are interacting with resources, the model reveals which information resources each agent interacts with and which information resources are shared between agents [36]. These shared resources indicate a need to share information and create dependencies between agents. For example, as one agent changes the information and another agent requires that information for other actions, there is a need to exchange that information. This captures how constraints in the work, as requirements for information to perform actions, combined with a system architecture (which defines how actions are allocated to the agents), create inherent communication requirements.

In addition, the sharing of information needs to be timed appropriately. When an information dependency exists between agents, the timing is dependent on when the receiver of information requires that information to perform its actions as well as when this information becomes available (which in turn is determined by the actions of the transmitting agent). Thus, information dependencies also create ordinality constraints that are based on the generation and use of the information. These ordinality constraints require agents to coordinate their activities such that all involved parties have access to the right information and the right time. For example, coordination is needed to make sure that no actor (in this case requesting specific information) would need to wait an unreasonable amount of time for another actor to provide the required information.

### Simulating Communication Demands and Strategies

Based on these requirements for information transfer, the work involved in these transfers can be modeled to analyze the additional work involved in communication. A model of this work can then be used to identify and analyze what strategies are available to the agents to dynamically manage communication overhead. To model communication overhead and strategies for managing these demands, the proposed framework has two elements, both automatically engendered by the modeling framework based on the identified communication requirements:
1) A set of additional teamwork actions that represent the work necessary to fulfill communication demands, with information states to represent each agent's awareness of the current system state. These teamwork actions and information resources represent the overhead of communication in terms of the additional taskload (the number of actions beyond the base set of actions in the work model). The actions can also be assigned an estimated duration to model the temporal overhead of communication.
2) The allocation and timing of the teamwork, determining what alternative strategies are available to the agents for dynamically managing this overhead, limited by ordinality constraints and dependencies.

The work involved in communicating information from one agent to another is modeled as a set of two actions: one for the agent that needs the information (the receiver) and one for the agent who has the information (the transmitter).

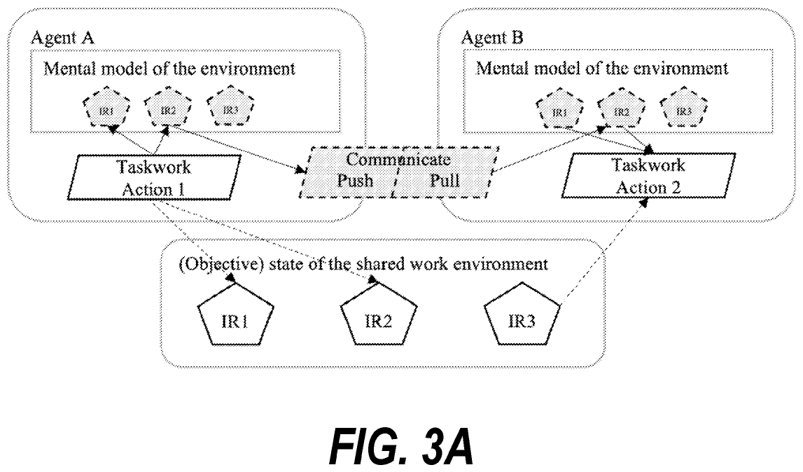

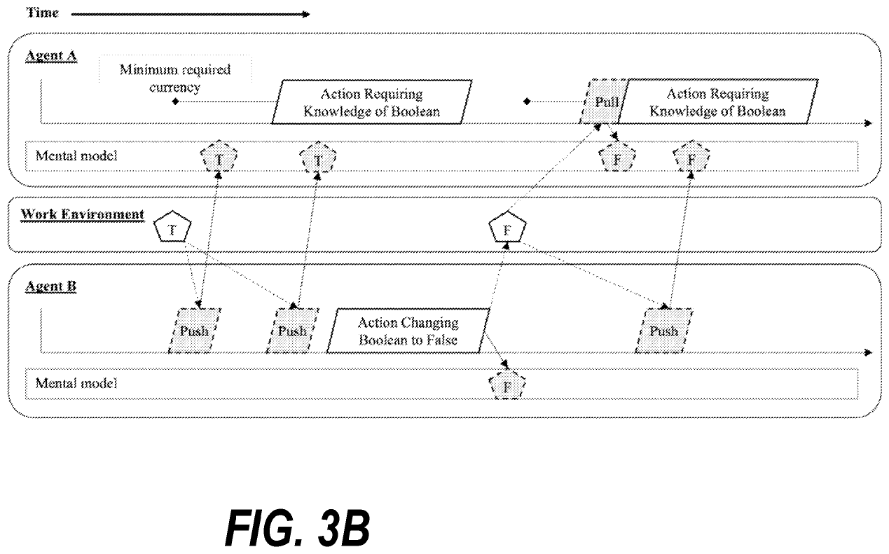

Together, they form a complementary pair of actions, shown in FIG. 3A as “push” and “pull” actions. By specifying their durations and the agent who is performing these actions, they represent the temporal and cognitive effort involved in communication. Durations can be estimated based on expected means of communication, such as whether the information transfer occurs through voice or digitally.

The teamwork actions ‘get’ the information resource that needs to be shared with another agent. They then ‘set’ a resource that represents the receiving agent's awareness of that information. Thus, for every communication action, there is also a ‘subjective’ resource, which value is updated through one of the communication actions. Thus, the ‘objective’ resource (representing the true state of the information) and its subjective counterpart may be different when new information has not been communicated yet.

All subjective resources together represent an agent's mental model or awareness of the state of the work environment. A lack of timely communication can affect the agents' awareness of the status of the work environment and that of other agents in the system, which can in turn impact the effectiveness of their actions. To model this interaction between communication behavior and taskwork behavior, we let an agent's taskwork actions use the ‘subjective’ information resources rather than the ‘objective’ resources. FIG. 3A shows this relationship between the subjective resource and taskwork actions (see Taskwork Action 2).

For example, at time t₁, the latitude of a UAV is φ(t₁) which is represented as an information resource (IR2). Agent1 holds a subjective copy φ_{agent1}. At time t₂, the value of the latitude of the UAV is updated to φ(t₂) but agent1 will continue to think the latitude of the UAV is φ(t₁) as that is the value that was last shared. To become aware of the new latitude, the agent would either need to explicitly request this information or receive an update from another agent who has direct access to this information. Agent1 holds the subjective version of IR2, which can only be updated by executing the action “update subjective resource”.

The pair of actions supports modeling alternative strategies for communication, characterized by what agent takes initiative in the required information exchange. The first method captures the receiver of information taking the initiative, driven by their need for the information. This corresponds to an explicit communication mechanism as described by Entin [17] because information is explicitly requested by the agent who needs it. The burden of coordinating explicit communication falls primarily on the agent who requests and later receives the information. Therefore, the teamwork action is assigned to this agent in the model.

The second method captures the agent who has the information (the transmitter) taking the initiative to share information, based on reasoning that accounts for the other agent's information needs. This method corresponds to implicit communication as described in the literature. In implicit communication, the taskload of coordinating information transfer is primarily carried by the agent who shares and transmits the information. This agent takes the initiative and therefore carries relatively a relatively higher share of the coordination costs. Thus, for implicit communication, this agent is assigned the communication action.

The impact of communication overhead on each agent's total taskload can also be determined by how this overhead is coordinated through time. This is modeled as a policy for determining the timing and recurrence of communication actions, capturing how agents might weigh when information needs to be transferred based on a variety of contextual factors. The timing of the communication actions is determined by two mechanisms. First, the communication action specifies its own next update time based on logical statements that can be modified by the modeler. In its simplest form, the logic can involve a fixed interval at which the owner of the information communicates that with other agents (hence, implicit communication without a request). In a more elaborate version, this logic may account for the transmitter agent's awareness of the receiving agent's information needs. For example, implicit communication is based on each team member having an understanding of what and when information is needed by the rest of the team, which can be represented in the timing logic of the communication action.

Second, the timing of communication is also determined by the required currency of information for executing the receiving agent's work. Information currency describes how much time has passed since that information was last updated. Requirements on currency specify how current the information needs to be to ensure that the receiving agent can successfully perform its actions. When information is older than the required currency, the receiving agent needs to make an explicit request for an information update.

Based on how these mechanisms interact with other actions and information resources, emergent patterns of communication arise, see FIG. 3B. This diagram shows communication about an information resource that can have two values: true (T) or false (F). Both agents have a copy of this resource that represents their awareness of the resource's value. Agent B currently holds the information and communicates this (through “Push” actions) to Agent A because this agent needs the information to successfully perform its action. This “Push” action updates Agent A's copy, representing they are now aware that the value is T. Agent B might periodically perform such “Push” actions based on their awareness of Agent A's information needs.

The line extended to the left of “Action Requiring Knowledge of Boolean” represents the required information currency (i.e., if Agent A hasn't been updated on the value of the information resource within the span of this line, an update should be requested before one can execute the action). This is the case after Agent B has just updated the information resources. Agent A realizes that they have not received an update in a while and therefore “Pull” the information before commencing their taskwork action.

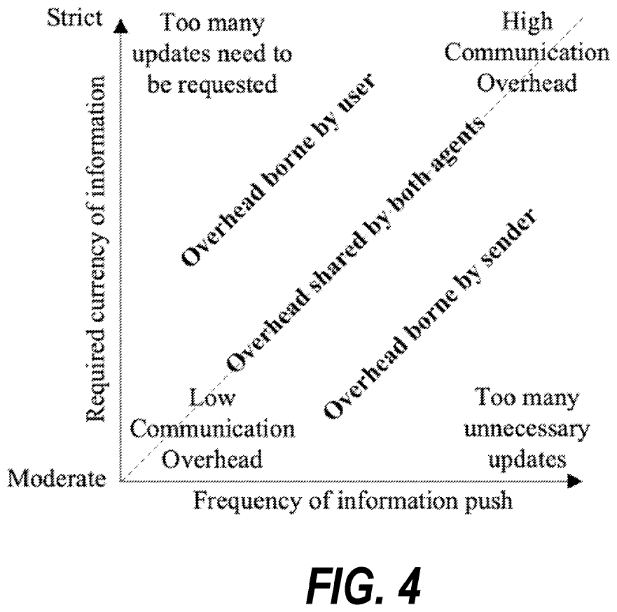

The emergent communication behavior, therefore, is a function of the frequency of information push as well as requirements (or bounds) on information currency, as shown in FIG. 4. Very strict information currency requirements will likely manifest in a more explicit communication strategy, as information regularly needs to be requested right before the receiving agent performs its action, resulting in a higher relative burden on the user of the information. An implicit strategy would be difficult as it would require highly accurate awareness of when the receiving agent will perform its information-relevant action(s). As information currency requirements are relaxed and more moderate, implicit (push) strategies of communication become more feasible, with more overhead borne by the sender of the information. With no currency requirements, the receiving agent will never need to explicitly request an update (pull) and communication can be purely implicit to improve common ground but with no hard constraints on necessary information sharing.

In most cases, it is reasonable to assume that information is shared through a combination of implicit and explicit communication. Thus, in the model, the two methods of communication are combined to create collective communication strategies. To share communication overhead between the sending and receiving parties, a line can be drawn (see FIG. 3) that represents equality between required information and the frequency of information push. In this strategy, the agents share the work involved in communication, with one agent requesting updates when required information currency has expired, and the other agent actively sending updates by some well-synchronized self-scheduling logic.

Implementations of the computational model can be used to explore communication strategies as described with reference to the study. The currency requirements and the self-scheduling logic are varied to characterize a range of available communication strategies.

The study illustrates the dynamic model of coordination through analysis of communication strategies in Uncrewed Aerial Systems (UAS) Traffic Management (UTM) operations. UTM is an example system for lower-altitude airspace that can combine crewed and uncrewed operations. Such UTM systems can include schemes for determining the roles, authorities, and competencies of different actors in a system, e.g., the FAA/NASA UTM ConOps [6] and UAM ConOps [7]. Compared to traditional ATM operations, UTM concepts of operation propose more distributed control that uses advanced (semi-)autonomous technologies to manage traffic, such as automated conflict detection and resolution.

FIG. 5B is a representation of an example architecture of a UTM system. Actors in the system can optionally include Remote Pilots in Command (RPIC), UAS Service Suppliers (USS), and/or Supplemental Data Service Providers (SDSS). The system includes a UTM Operations Center, tasked with supervising the UTM system and managing the airspace. Information sharing is performed primarily through an Uncrewed Traffic Information Management System. The UTM system also interfaces with Air Traffic Control (ATC) in the area via the Flight Information Management System (FIMS).

The study examines communication and coordination strategies during contingency management in UTM.

Contingency management is defined as the set of system functions and procedures for responding to anomalies that disrupt standard operations. In the example UTM system, these system functions are distributed amongst multiple parties, so communication and coordination are critical to the system's ability to handle anomalies. Information transfer also needs to be time efficient, as anomalies often require quick responses. During a time-sensitive response, coordination of information sharing can either put the team in control of the task or lead to a loss of control.

### Operational Scenario

The study included a case study of an operational scenario. The operational scenario explored the dynamics and resource uses of communication and coordination during a simulated contingency, specifically a failure of a critical radar while multiple vehicles are operating in the radar's coverage area. It should be understood that any type of failure scenario is contemplated by implementations of the present disclosure, and that the radar failure is only a non-limiting example. Additional non-limiting examples of failures include failures of ground-based detection capabilities including ground-based radars, remote ID recievers, ADS-B In, etc.

The study included creating a detailed functional model of the work involved in UTM contingency management. The NASA/FAA UTM concept of operation was used as a basis for this model. In addition, as part of related research, the authors conducted a Cognitive Task Analysis (CTA) [37, 38] to analyze the cognitive work in the UTM system. Semi-structured interviews were conducted with subject-matter experts to characterize the work domain constraints and the strategies for coordinating with other stakeholders in the UTM system. This study provided more insights into the communication and coordination strategies and informed the functions and actions that were modeled.

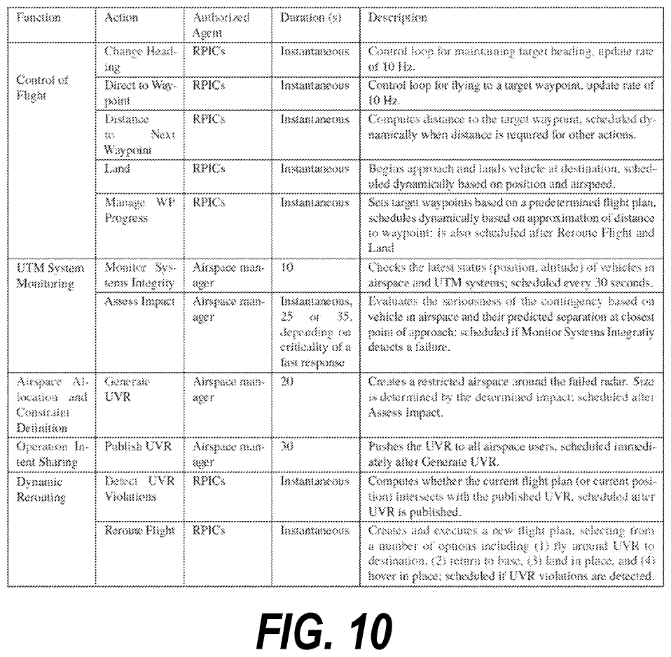

FIG. 10 lists all the actions in the work model, how these actions are scheduled during a simulation run and the timing strategies of each action. Two work models were developed. First, one work model represents the functions and actions required for operating one or more UAS. These actions are primarily focused on basic flight functions.

The ‘flight dynamics’ action is the driving force of the work model and gets the simulation started by initiating the movements of the agents. ‘Land’, ‘change heading’, ‘change speed’, ‘direct to waypoint’, ‘distance to next waypoint’, and ‘manage waypoint progress’ are all actions that must occur every flight to maintain baseline operations and complete the flight plan. These actions are primarily performed by RPICs and vehicle automation to control and navigate the UAV.
Flight Dynamics are updated at a 0.1 s interval.

The second work model captures the work needed for higher-level system management. This model focuses on actions for contingency management, which represent the work required for the system's immediate response to a contingency when it arises. These actions include ‘monitor systems integrity’ that ensures all operations are running smoothly by checking the positions of all UAVs and the radar status. Specific strategies for monitoring can be modeled as alternative ways of computing this action's next update time. For the example scenario, a simple interval is used to simulate an agent sampling the system's status every few seconds or minutes. The lower the interval, the sooner a contingency is detected. However, too low values could pose an unrealistic assumption of what an agent is capable of doing considering the other actions that the agent needs to also perform. Explorative testing with alternative monitoring intervals revealed that 30 seconds creates desirable system behavior. Values on the order of 100 seconds and larger resulted in undesirable system behaviors, such as failure to timely detect and respond to the contingency.

Following contingency detection is contingency response. When the contingency is detected, ‘assess impact’ is scheduled to determine the severity of the disturbance. Based on the assessment, the action ‘Generate UVR’ creates a UAS Volume Reservations (UVR) whose size and duration correspond to the severity of the contingency. Information on the UVR is then sent out to the affected airspace users using the ‘communicate UVR’ action. To respond to new airspace constraints, the action ‘detect conflict’ represents an agent monitoring its future flight path and detecting issues with its flight plan intersecting constrained airspace. If such issues arise, ‘reroute-flight’ is scheduled to adjust the flight path and resolve any conflicts.

The framework supports the simulation of alternate re-routing strategies. For this example scenario, reroute strategies include flying around a UVR, hovering in place for the duration of the UVR, turning around and flying back to one's departure vertiport, or landing in place. The option that is selected depends on the vehicle's battery level at the time of the decision, the priority level of the vehicle, the location of the vehicle along its intended route, and whether the vehicle is currently inside or outside the UVR.

### Scenario and Alternative Communication Strategies

The scenario includes low-altitude airspace operations in Columbus, Ohio. Two UASs operate in the same airspace.

UAS 1 is a high-priority medical UAS transporting organs from Marysville, Ohio to the Wexner Medical Center in central Columbus for use in transplant surgery. UAS 1 is a hybrid delivery drone with a weight of approximately 1500 lbs including payload. In the scenario, UAS 1 is traveling at 150 knots and cruising at an altitude of 280 feet. UAS 2 is a smaller police surveillance drone with a weight of approximately 25 lbs, conducting regular surveillance over a neighborhood in west Columbus. UAS 2 has medium priority meaning its mission is important but can be delayed or aborted if necessary. UAS 2 is circling the assigned neighborhood at an airspeed of about 30 knots and a cruising altitude of about 150 feet. A simulated radar failure occurs about three minutes into the scenario, requiring a service provider (e.g., an airspace manager) to activate the contingency management protocol.

The scenario involves three human agents along with the two UAS. The human agents in this work model include RPIC 1 and RPIC 2, representing the human operators for the first and second UAS, respectively, and the service provider, representing the human agent in the UTM Operations Center who oversees all operations within the given airspace and manages system performance. The work allocation reflects the current envisioned roles, as specified in the ConOps developed by NASA and the FAA (e.g., [7]), shown in FIG. 10. The RPICs are primarily responsible for flight control, aircraft and obstacle avoidance, and dynamic rerouting. The service provider conducts actions associated with UTM system monitoring and airspace allocation and constraint definition. The simulation framework supports easy testing of alternative allocations, yet to keep the number of conditions manageable for this example scenario, a single allocation was tested.

Based on the allocation of functions, several information resources need to be shared between the agents throughout the scenario. These resources include, among others, radar status, UAS positions and waypoints, and UAS flight information such as heading, altitude, and speed. With these shared resources and based on results from the cognitive task analysis (CTA), communication and coordination between the RPICs and the service provider were deemed critical to system performance. Furthermore, awareness of UAS positions is assumed to play an important role in monitoring the system integrity (e.g., through a comparison of the radar UAS locations and the real UAS locations) and in the subsequent rerouting function. Thus, the further analysis focuses specifically on the communication of vehicle position between the RPICs and the service provider.

The subjective resources in the work model are coordinates of the UAS and these resources are used to illustrate alternate communication strategies between the service provider and the RPICs. Communication in the example can occur in one of two ways: an update is sent by the RPIC, or if the information currency expires resulting in the service provider needing to request an update. An implicit method of communication is when the RPICs send timely updates of the UAS's position, coordinates, and altitude, with the RPIC bearing most of the coordination load. An explicit method of communication is when the service provider requests the UAS's position explicitly; in this mode, the service provider bears the majority of the coordination load.

The two methods only represent the extremes of the coordination involved. The communication strategy ultimately is a result of how information currency constraints and the timing of information pushes interact with each other, dividing the coordination load among the service provider and the RPICs. The scenario is simulated to evaluate alternative communication strategies. A set of five values of information currency constraints and information push intervals are combined to create a five-by-five experiment design, totaling 25 alternative communication strategies that are evaluated in the simulation.

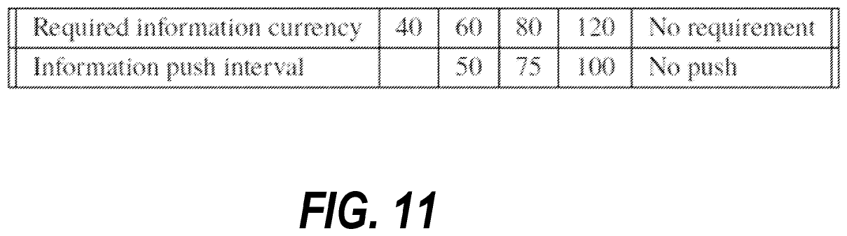

The values of required information currency and implicit interval time are given in FIG. 11. The range for these values was chosen based on initial testing with the simulation. Simulations with very lenient information currency requirements and long push intervals (larger than 150 seconds) showed little to no noticeable changes between different simulation conditions. Very strict currency requirements and frequent push intervals caused extremely high communication overhead which were deemed unreasonable and unnecessary (the system performance with less communication was still acceptable).

The total duration of the simulated scenario is around twelve minutes. All simulation runs resulted in the system successfully responding to the contingency by creating UVRs and rerouting flights. This indicates that the design of the work model successfully captures the work that is necessary for successful responses, representing at least the minimally required work to bring about desirable system responses. Simulations also revealed no change in the system performance (assessed by comparing flight paths of the UAS) between the various conditions, confirming that all communication strategies were successful in sharing information in a sufficiently timely manner.

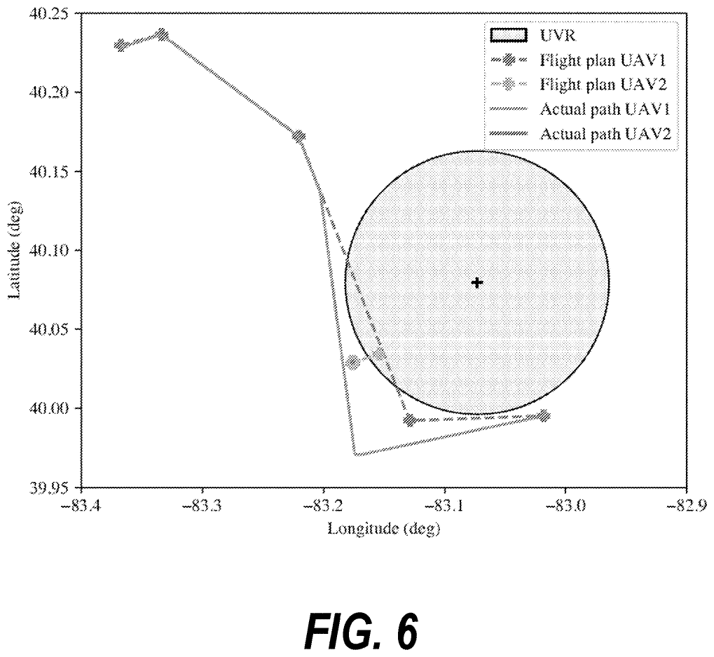

FIG. 6 shows a top view of the traffic scenario. The blue dotted line shows the intended flight plan for UAS1, which flies from Marysville, Ohio in the top left corner to the Wexner Medical Center, the lower right waypoint. The yellow dotted line shows the flight plan for UAS2, which starts mid-air surveying (flying in circles around) a sports field and intends to fly back to the landing site not far from its current position (indicated with the yellow extending to the right). The radar is positioned at the Ohio State University airport, with a coverage radius of about 5 NM. The gray area shows the UVR that is instated when the radar fails, which covers the full area monitored by the radar. The results from the simulation are plotted as a solid green line (UAS1) and a solid red line (UAS2), showing how the UASs both rerouted around the UVR.

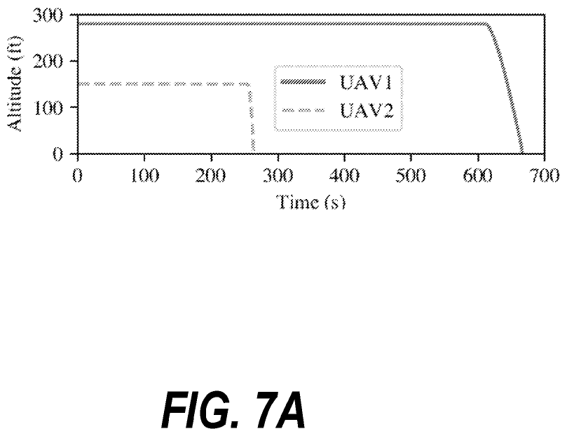

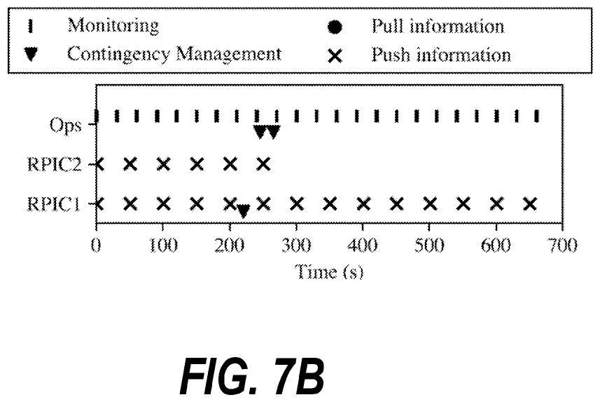

FIG. 7A shows the altitudes of the vehicles. FIG. 7B shows a trace of when actions are performed by each agent.

Each symbol represents a single action being performed, with distinctions between monitoring actions (corresponding to actions in the function “UTM System Monitoring”, see FIG. 10), contingency management (functions “Airspace Allocation and Constraint Definition”, “Operation Intent Sharing”, “Aircraft and Obstacle Avoidance”, and “Dynamic Rerouting”), and communication (including both push and pull of information resources). Actions for the function “Control of Flight” have been filtered out as these occur at a high frequency (cluttering the time traces) and are also assumed to be performed by automated features.

The time trace and altitude profile have the radar failure occur 200 seconds into the scenario. The contingency management actions are performed immediately after this failure is detected. After assessing the impact and rerouting the flights, UAS1 is deemed a high-priority flight and therefore continues but has an alternate flight route (around the UVR). UAS2 has lower priority and therefore is requested to land. It cannot fly back to its intended landing site because it falls within the UVR, so its lands at the sports field.

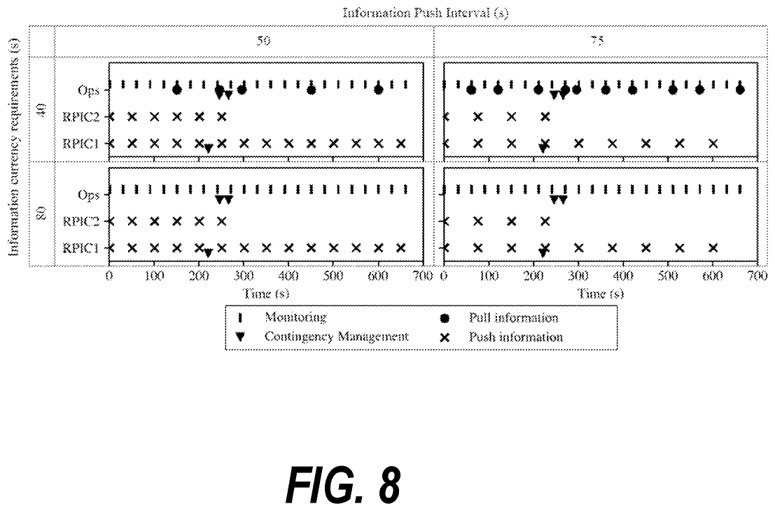

FIG. 8 shows a matrix of time traces for communication, monitoring, and contingency actions for four alternate communication strategies, each from a different simulation run. The rows show two different information currency requirements at 40 and 80 seconds. The columns show two information push intervals at 50 and 75 seconds. In the top left panel, the RPICs bear a significant amount of the communication load, with status updates being shared every 50 seconds. There are some instances where the airspace manager requests more up-to-date information, with an associated communication load for the airspace manager. This load on the airspace manager is higher during the management of the contingency (between 200 and 300 seconds into the scenario).

In the top right panel, the load on the RPICs is reduced, with an increased interval between communication actions. With no change in information currency requirements and a reduction in the interval compared to the previous time trace, the airspace manager now needs to request information more frequently resulting in a higher communication load for the airspace manager. This communication load again is highest during the most critical phase of the scenario, the handling of the contingency.

The bottom two panels show a combination of parameters that results in no communication load for the airspace manager, with the RPICs providing information just in time to meet currency requirements. This demonstrates how communication can be fully implicit (shifting initiative and overhead to the RPICs) when the information push interval is shorter than the required information currency. The lower left has the RPIC sometime providing status updates that are redundant based on fairly moderate currency requirements, yet could still be construed as effective for maintaining and repairing common ground. In the aggregate, a comparison between the top two panels shows that an increase in information push interval increases the communication load on the airspace manager. Likewise, a comparison between the panels in the right (last) column shows relaxing information currency requirements reduces the communication load on the airspace manager.

Considering the timing of the teamwork actions, the results show how the communication load for the airspace manager is focused around the contingency event, which is also the most critical period of the scenario. Without frequent updates from the RPICs, the airspace manager needs to request this information explicitly, contributing to further workload in what is likely to already be a high-workload situation.

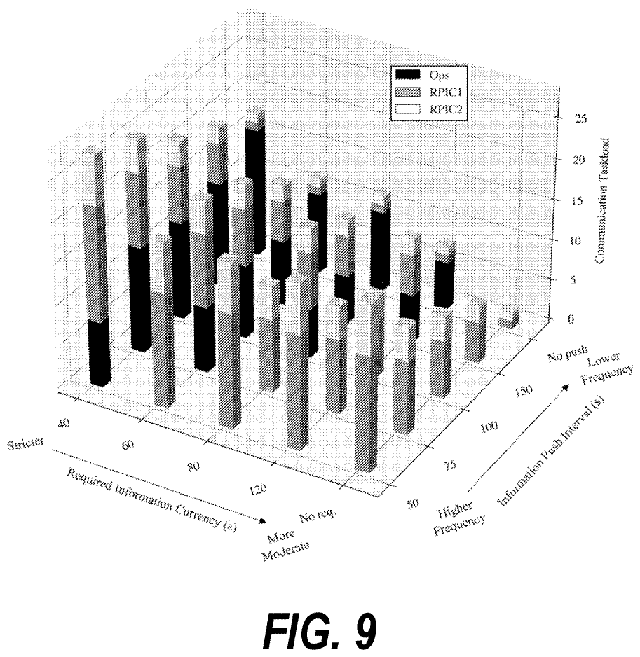

FIG. 9 shows the overall communication load for each simulation condition. The results show that generally, communication overhead is reduced as information currency requirements are relaxed and information push intervals are increased. While it makes sense that there is a lower demand for communication, it also means that the airspace manager is performing its actions with more-outdated information, which could increase the risk of poor decisions or the failure to recognize mismatches or breakdowns in the common ground between the RPICs and the airspace manager.

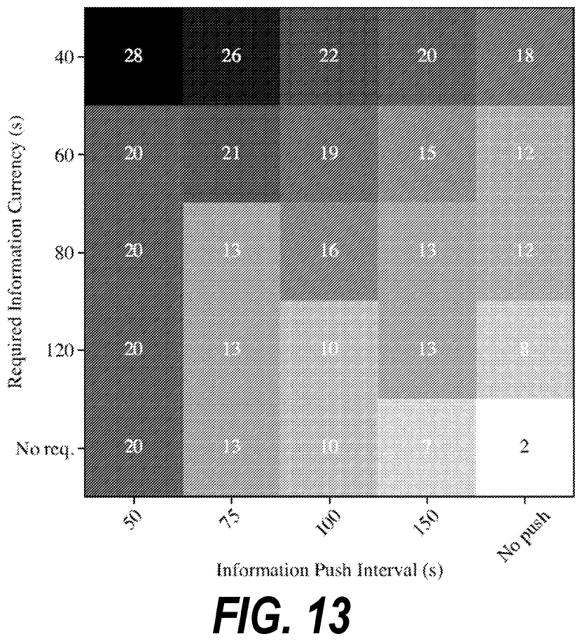

FIG. 13 shows the overall communication taskload for each simulation condition. The units of communication taskload in this figure represent the total number of communication actions performed throughout the scenario, both push and pull. The study deliberately chose to characterize total overhead as the number of actions to minimize the number of modeling assumptions and to provide an objective estimate of the demands on the agents. Implementations of the present disclosure include modeling that estimates the workload associated with these communication actions, which, aside from the number of actions, can be dependent on communication modality and operator experience, and other factors.

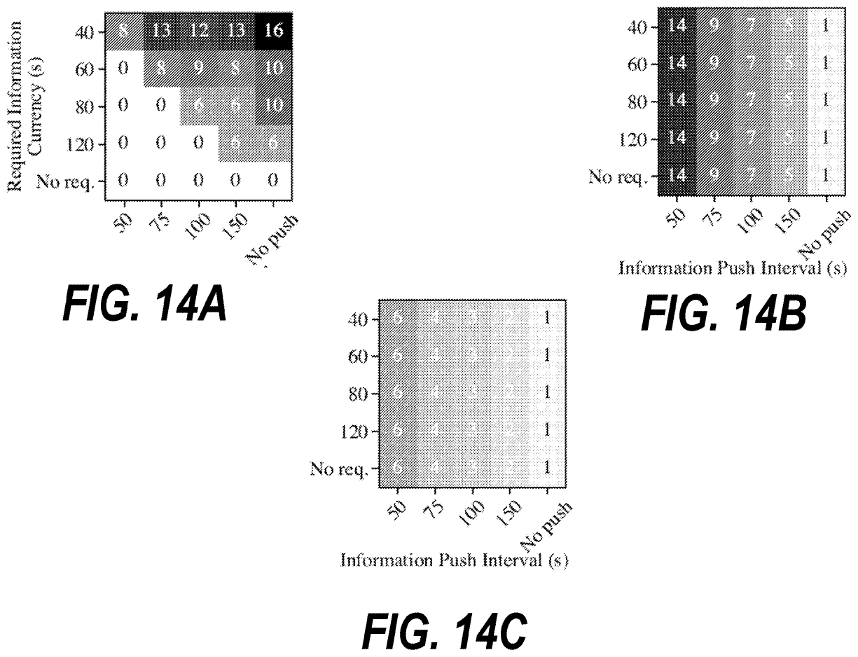

FIGS. 14A-14C illustrates total communications taskload per agent in the simulation conditions: FIG. 14A illustrates communication taskload for an example service provider, FIG. 14B illustrates communication taskload for a first example RPIC and FIG. 14C illustrates communication taskload for a second example RPIC.

Furthermore, for a given currency requirement, the communication load generally decreases with an increase in push interval. This is because the number of updates given by the RPICs decreases when the push interval increases. At the same time, however, this decrease in implicit updates causes an increase in explicit requests from the receiving agent (the airspace manager). The decrease in RPIC updates is usually stronger than the increase in explicit requests, leading to a net decrease in communication overhead.

Likewise, for a fixed information push interval, when information currency requirements become stricter, the communication load generally increases. The number of times information can be reused before a new update is necessary decreases, which increases the overall communication load due to the increased number of explicit updates.

A change in currency requirements does, however, not affect how often the pilots update the information through the implicit interval, it merely increases the number of times that information is considered outdated and must be requested from the pilots. FIG. 9 also shows how the communication load is divided among the three agents. The figure shows that alternative strategies result in highly different relative communication loads on the agents. In general, the communication load is more evenly distributed among the three agents when required information currency is very similar to the information push interval. When the required information currency is higher than the implicit interval, most of the communication load is experienced by the two pilots. When there is no information currency requirement, as the extreme, all communication load falls upon pilots.

Vice versa, when the required information currency is lower than the implicit interval, communication load is primarily imposed on the airspace manager. Finally, the figure reveals that the communication load is lowest, while also not heavily skewed towards one agent, when the information push interval is a few seconds slower than double the required information currency. For example, see the bar graph where the required currency is 60 and the interval is 100.

When the interval is a few seconds less than the required currency, the airspace manager requests an explicit update between two implicit updates equalizing the communication load distribution.

Two patterns show that the general trends described above can interact to create positive and/or negative emergent effects. The first pattern, combining a required currency of 60 s with an interval of 75 s, has a higher-than-expected communication load. This increased load is caused by a miscoordination of the timing of implicit updates relative to when the information is needed. Before every implicit update, currency expiration triggers an explicit update. This additional update just before the next implicit update increases the overall communication load.

The second pattern, “below the diagonal” (e.g., combining a required currency of 80 s with an interval of 75 s), has a relatively low communication taskload with relatively high information currency. This reduced load signals effective coordination. Relative to the strategy with an interval of 50 s, an interval of 75 s reduced the number of implicit updates yet did not increase the number of explicit requests. The additional implicit updates with an interval of 50 s were unnecessary given when the information was needed by the airspace manager. Thus, the latter strategy represents a better synchronization of communication actions, in which the RPICs timed their implicit updates to align with the information needs of the service provider, resulting in an overall lower communication load.

Both these cases illustrate the effect of timing and synchronization in communicating time-critical information. In particular, the first case demonstrates how the miscoordination of information exchange results in a higher-than-necessary communication load. The second case shows how careful calibration of when information is communicated relative to when it is needed can result in significantly lower communication loads.

The operational scenarios described herein show that implementations of the present disclosure can provide insight into the communication demands and/or strategies for air operations. The results illustrate tradeoffs between communication strategies that can be used to determine communication strategies for operating air operations, for example by selecting among different communication strategies to respond to different scenarios including sensor failures, UAS failures, weather, emergencies, and any other event that can impact the performance of the UAS and/or require coordination and/or communication among UAS and/or UAS operators to mitigate the scenario.

The example modeling and simulation approach used in the study provides a way to further specify operational concepts involving distributed work while envisioning artifacts for supporting communication. For example, the evaluation of alternative strategies can be used to identify requirements for what strategies should minimally be supported through procedures for digital or voice communication. In addition, given that future low-altitude airspace operations are likely to use more autonomous capabilities, insights from the model can be used to identify design requirements for such tools.

Implementations of the present disclosure also support the verification of the feasibility of envisioned operations and the deployment of new solutions, including the identification of potential ‘problem areas’ in terms of communication and coordination. This can be extended to evaluate the robustness of envisioned as well as existing operations, testing how well a system responds at the boundary of a performance envelope [21, 41]. By scaling up through fast-time evaluation, the system's response can be mapped to identify and analyze potential vulnerabilities. An evaluation can be similar to the scenario that was simulated for this study but with varying inputs to test variations of the base scenario. For example, the approach can be used to evaluate an envisioned procedure and identify scenarios in which the system's response is too slow to keep pace with events in the work environment, which is a known failure mode in distributed work [42].

To develop the models and validate their predictions, implementations of the present disclosure can include empirical studies. The use of simulation in a loop of empirically based model development and model-driven empirical research is contemplated by the present disclosure. [25]. The operational scenario discussed in this paper used iterative knowledge elicitation as a basis for developing the computational model. Interviews with subject-matter experts provided key insights into the envisioned operational flow of the system and decision strategies during various contingencies. The modeling and simulation of these operational flows provided complementary quantitative insight into how envisioned strategies would play out dynamically, which is difficult to predict given the complexities and interdependencies in the system.

This combines the benefit of the simulation approach (particularly its ability to do much larger-scale exploration than otherwise possible with solely physical testing) with naturalistic observations to ensure the model captures the important aspects of work in complex operations. This complementarity can eventually allow researchers to distinguish between incorrect assumptions or errors in the model and underlying issues or patterns in the work system, like the varying workload associated with the timing of communication relative to the required currency of information.

It should also be understood that, while the examples described in the present disclosure are configured for low-altitude air transportation, the model-based approach developed and illustrated here can be used to model and/or improve communications in other distributed systems including disaster response and space operations.

It should be appreciated that the logical operations described herein with respect to the various figures may be implemented (1) as a sequence of computer-implemented acts or program modules (i.e., software) running on a computing device (e.g., the computing device described in FIG. 12), (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special-purpose digital logic, and any combination thereof. It should also be appreciated that more or fewer operations may be performed than shown in the figures and described herein. These operations may also be performed in a different order than those described herein.

Referring to FIG. 12, an example computing device 1200 upon which the methods described herein may be implemented is illustrated. It should be understood that the example computing device 1200 is only one example of a suitable computing environment upon which the methods described herein may be implemented. Optionally, the computing device 1200 can be a well-known computing system including, but not limited to, personal computers, servers, handheld or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In its most basic configuration, computing device 1200 typically includes at least one processing unit 1206 and system memory 1204. Depending on the exact configuration and type of computing device, system memory 1204 may be volatile (such as random access memory (RAM)), non-volatile (such as read-only memory (ROM), flash memory, etc.), or some combination of the two. This most basic configuration is illustrated in FIG. 4 by dashed line 1202. The processing unit 1206 may be a standard programmable processor that performs arithmetic and logic operations necessary for operation of the computing device 1200. The computing device 1200 may also include a bus or other communication mechanism for communicating information among various components of the computing device 1200.

Computing device 1200 may have additional features/functionality. For example, computing device 1200 may include additional storage such as removable storage 1208 and non-removable storage 1210 including, but not limited to, magnetic or optical disks or tapes. Computing device 1200 may also contain network connection(s) 1216 that allow the device to communicate with other devices. Computing device 1200 may also have input device(s) 1214 such as a keyboard, mouse, touch screen, etc. Output device(s) 1212 such as a display, speakers, printer, etc. may also be included. The additional devices may be connected to the bus in order to facilitate communication of data among the components of the computing device 1200. All these devices are well-known in the art and need not be discussed at length here.

The processing unit 1206 may be configured to execute program code encoded in tangible, computer-readable media. Tangible, computer-readable media refers to any media that is capable of providing data that causes the computing device 1200 (i.e., a machine) to operate in a particular fashion. Various computer-readable media may be utilized to provide instructions to the processing unit 1206 for execution. Example tangible, computer-readable media may include, but is not limited to, volatile media, non-volatile media, removable media and non-removable media implemented in any method or technology for storage of information such as computer-readable instructions, data structures, program modules or other data. System memory 1204, removable storage 1208, and non-removable storage 1210 are all examples of tangible, computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 1206 may execute program code stored in the system memory 1204. For example, the bus may carry data to the system memory 1204, from which the processing unit 1206 receives and executes instructions. The data received by the system memory 1204 may optionally be stored on the removable storage 1208 or the non-removable storage 1210 before or after execution by the processing unit 1206.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high-level procedural or object-oriented programming language to communicate with a computer system. However, the program(s) can be implemented in assembly or machine language, if desired. In any case, the language may be a compiled or interpreted language and it may be combined with hardware implementations.

### REFERENCES

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The following patents, applications, and publications, as listed below and throughout this document, describes various application and systems that could be used in combination the exemplary system and are hereby incorporated by reference in their entirety herein.
[1] Norman, D. A., “The ‘problem’ with automation: inappropriate feedback and interaction, not ‘over-automation’,” Philosophical Transactions of the Royal Society of London. B, Biological Sciences, Vol. 327, No. 1241, 1990, pp. 585-593. https: //doi.org/10.1098/rtsb.1990.0101
[2] Holbrook, J., Prinzel, L. J., Chancey, E. T., Shively, R. J., Feary, M., Dao, Q., Ballin, M. G., and Teubert, C., Enabling Urban Air Mobility: Human-Autonomy Teaming Research Challenges and Recommendations, 2020. https://doi.org/10.2514/6.2020-3250
[3] Adduru, V., Ammann, O. C., Cardoza, C. T., Stewart, M. J., Avrekh, I., Matthews, B. L., Holbrook, J. B., Prinzel, L. J., and Smith, B. E., “Human Performance Contributions to Safety in Commercial Aviation,” 2019. URL https: //ntrs.nasa.gov/citations/20190001429
[4] Nijveldt, R., and Ijtsma, M., Cognitive Task Analysis of Contingency Management in Future Unmanned Aircraft Systems Traffic Management, 2022. https://doi.org/10.2514/6.2022-3620.
[5] Klein, G., Woods, D., Bradshaw, J., Hoffman, R., and Feltovich, P., “Ten challenges for making automation a “team player” in joint human-agent activity,” IEEE Intelligent Systems, Vol. 19, No. 6, 2004, pp. 91-95. https://doi.org/10.1109/MIS.2004.74
[6] “UTM Concept of Operations Version 2.0,” Tech. rep., National Aeronautic and Space Administration, 2020. URL https://www.faa.gov/researchdevelopment/trafficmanagement/utm-concept-operations-version-20-utm-conops-v20
[7] “UAM Vision Concept of Operations,” Tech. rep., National Aeronautics and Space Administration (NASA), 2020. URL https://ntrs.nasa.gov/citations/20205011091
[8] Woods, D., and Dekker, S., “Anticipating the effects of technological change: A new era of dynamics for human factors,” Theoretical Issues in Ergonomics Science, Vol. 1, No. 3, 2000, pp. 272-282. https://doi.org/10.1080/14639220110037452
[9] Smith, P. J., Billings, C. E., Mccoy, C. E., and Orasanu, J., “Alternative Architectures for Distributed Cooperative ProblemSolving in the National Airspace System,” Tech. rep., Ohio Sate University, Columbus, OH, 1999. URL https://ntrs.nasa.gov/ citations/20020025989
[10] Salas, E., Sims, D. E., and Shawn Burke, C., “Is there A “big five” in teamwork?” Small Group Research, Vol. 36, No. 5, 2005, pp. 555-599. https://doi.org/10.1177/1046496405277134
[11] González-Romá, V., and Hernández, A., “Climate uniformity: Its influence on team communication quality, task conflict, and team performance.” Journal of Applied Psychology, Vol. 99, No. 6, 2014, pp. 1042-1058. https://doi.org/10.1037/a0037868
[12] Marlow, S. L., Lacerenza, C. N., Paoletti, J., Burke, C. S., and Salas, E., “Does team communication represent a one-size-fits-all approach ?: A meta-analysis of team communication and performance,” Organizational Behavior and Human Decision Processes, Vol. 144, 2018, pp. 145-170. https://doi.org/10.1016/j.obhdp.2017.08.001
[13] Maguire, L. M., “Managing the hidden costs of coordination,” Queue, Vol. 17, No. 6, 2019, pp. 71-93. https: //doi. org/ 10.1145/3380774.3380779
[14] Klinger, D., and Klein, G., “An Accident Waiting to Happen,” Ergonomics in Design, Vol. 7, No. 3, 1999, pp. 20-25. https://doi org/10.1177/106480469900700305
[15] Klein, G., Feltovich, P. J., Bradshaw, J. M., and Woods, D. D., Common Ground and Coordination in Joint Activity, John Wiley & Sons, Ltd, 2005, Chap. 6, pp. 139-184. https://doi.org/https://doi.org/10.1002/0471739448.ch6
[16] Salas, E., Cooke, N. J., and Rosen, M. A., “On Teams, Teamwork, and Team Performance: Discoveries and Developments,” Human Factors, Vol. 50, No. 3, 2008, pp. 540-547. https://doi.org/10.1518/001872008X288457, pMID: 18689065.
[17] Entin, E. E., and Serfaty, D., “Adaptive Team Coordination,” Human Factors: The Journal of the Human Factors and Ergonomics Society, Vol. 41, No. 2, 1999, pp. 312-325. https://doi.org/10.1518/001872099779591196, publisher: SAGE PublicationsSage CA: Los Angeles, CA.
[18] Espinosa, J. A., Lerch, F. J., and Kraut, R. E., “Explicit versus implicit coordination mechanisms and task dependencies: One size does not fit all.” Team cognition: Understanding the factors that drive process and performance., American Psychological Association, Washington, DC, US, 2004, pp. 107-129. https://doi.org/10.1037/10690-006
[19] Trafton, J. G., Cassimatis, N. L., Bugajska, M. D., Brock, D. P., Mintz, F. E., and Schultz, A. C., “Enabling effective human-robot interaction using perspective-taking in robots,” IEEE Transactions on Systems, Man, and Cybernetics Part A: Systems and Humans., Vol. 35, No. 4, 2005, pp. 460-470. https://doi.org/10.1109/TSMCA.2005.850592.
[20] Hoffman, R. R., and Woods, D. D., “Beyond Simon's slice: Five fundamental trade-offs that bound the performance of macrocognitive work systems,” IEEE Intelligent Systems, Vol. 26, No. 6, 2011, pp. 67-71. https://doi.org/10.1109/MIS.2011.97
[21] Bisantz, A., and Roth, E., “Analysis of Cognitive Work,” Reviews of Human Factors and Ergonomics, Vol. 3, No. 1, 2007, pp. 1-43. https://doi.org/10.1518/155723408x299825
[22] Miller, M. J., and Feigh, K. M., “Addressing the envisioned world problem: a case study in human spaceflight operations,” Design Science, Vol. 5, 2019, p. e3. https://doi.org/10.1017/dsj.2019.2.
[23] Vicente, K., Cognitive Work Analysis: Toward Safe, Productive, and Healthy Computer-Based Work, Lawrence Erlbaum Associates Publishers, 1999. https://doi.org/10.1201/b12457
[24] Ockerman, J., and Pritchett, A., “A Review and Reappraisal of Task Guidance: Aiding Workers in Procedure Following,” International Journal of Cognitive Ergonomics, Vol. 4, No. 3, 2000, pp. 191-212. https://doi.org/10.1207/S15327566IJCE0403_2. publisher: Routledge.
[25] Woods, D. D., and Roth, E. M., Symbolic Al Computer Simulations as Tools for Investigating the Dynamics of Joint Cognitive Systems, L. Erlbaum Associates Inc., USA, 1995, pp. 75-90. https://doi.org/10.4324/9780203773673
[26] Pritchett, A. R., Feigh, K. M., Kim, S. Y., and Kannan, S. K., “Work Models that Compute to describe multiagent concepts of operation: Part 1,” Journal of Aerospace Information Systems, Vol. 11, No. 10, 2014, pp. 610-622. https:// doi.org/10.2514/1.1010146
[27] Laird, J., “The Soar Cognitive Architecture,” Computer Science, 2012. https://doi.org/10.7551/mitpress/7688.001.0001.
[28] Ritter, F. E., Tehranchi, F., and Oury, J. D., “ACT-R: A cognitive architecture for modeling cognition,” Wiley Interdisciplinary Reviews: Cognitive Science, Vol. 10, No. 3, 2019. https://doi.org/10.1002/wcs.1488
[29] Clancey, W. J., Sachs, P., Sierhuis, M., and Van Hoof, R., “Brahms: Simulating practice for work systems design,” International Journal of Human Computer Studies, Vol. 49, No. 6, 1998, pp. 831-865. https://doi.org/10.1006/ijhc.1998.0229
[30] Pritchett, A. R., Kim, S. Y., Kannan, S. K., and Feigh, K., “Simulating situated work,” 2011 IEEE International MultiDisciplinary Conference on Cognitive Methods in Situation Awareness and Decision Support (CogSIMA), IEEE, 2011, pp. 66-73. https://doi.org/10.1109/COGSIMA.2011.5753756
[31] Tambe, M., “Agent Architectures for Flexible, Practical Teamwork,” Proceedings of the Fourteenth National Conference on Artificial Intelligence and Ninth Conference on Innovative Applications of Artificial Intelligence, AAAI Press, 1997, p. 22-28. URL https://dl.acm.org/doi/10.5555/1867406.1867410.
[32] Sierhuis, M., Bradshaw, J. M., Acquisti, A., van Hoof, R., and Jeffers, R., “Human-Agent Teamwork and Adjustable Autonomy in Practice,” 2003. https://doi.org/10.1184/r1/14225930.v1
[33] Mitchell, D. K., “Advanced Improved Performance Research Integration Tool (IMPRINT) Vetronics Technology Test Bed Model Development,” Army Research Laboratory, No. September, 2003. URL http://oai.dtic.mil/oai/oai? verb=getRecord& metadataPrefix=html&identifier=ADA417350
[34] Pritchett, A. R., Bhattacharyya, R. P., and IJtsma, M., “Computational Assessment of Authority and Responsibility in Air Traffic Concepts of Operation,” Journal of Air Transportation, Vol. 24, No. 3, 2016, pp. 93-102. https://doi.org/10.2514/1.D0024
[35] Feigh, K. M., Pritchett, A. R., Mamessier, S., and Gelman, G., “Generic Agent Models for Simulations of Concepts of Operation: Part 2,” Journal of Aerospace Information Systems, Vol. 11, No. 10, 2014, pp. 623-631. https://doi.org/10.2514/1.1010147
[36] Ma, L., Ijtsma, M., Feigh, K., and Pritchett, A., “Metrics for Human-Robot Team Design: A Teamwork Perspective on Evaluation of Human-Robot Teams,” ACM Transactions on Human-Robot Interaction, Vol. 11, 2022. https://doi.org/10.1145/3522581
[37] Klein, G. A., Calderwood, R., and Macgregor, D., “Critical decision method for eliciting knowledge,” Ieee Transactions On Systems Man And Cybernetics, Vol. 19, No. 3, 1989, pp. 462-472. https://doi.org/10.1109/21.31053
[38] Roth, E. M., “Uncovering the Requirements of Cognitive Work,” Human Factors: The Journal of the Human Factors and Ergonomics Society, Vol. 50, No. 3, 2008, pp. 475-480. https://doi.org/10.1518/001872008x288556.
[39] Pritchett, A., and Fleming, E. S., “Pilot compliance to TCAS Resolution Advisories,” 2013 IEEE/AIAA 32nd Digital Avionics Systems Conference (DASC), 2013, pp. 6B6-1-6B6-13. https://doi.org/10.1109/DASC.2013.6712618
[40] Scheff, S., Friedman-Berg, F., Shively, J., and Carter, A., “Human Factors Challenges in Urban Air Mobility,” Proceedings of the Human Factors and Ergonomics Society Annual Meeting, Vol. 64, No. 1, 2020, pp. 179-182. https://doi.org/10.1177/1071181320641044
[41] Woods, D., and Balkin, E., “Resiliency Trade Space Study: The Interaction of Degraded C2 Link and Detect and Avoid Autonomy on Unmanned Aircraft,” Tech. rep., 06 2018. https://doi.org/10.13140/rg.2.2.19395.86564
[42] Woods, D., and Branlat, M., “Basic patterns in how adaptive systems fail,” Resilience Engineering in Practice: A Guidebook, 2011, pp. 127-144. https://doi.org/10.1201/9781317065265

What is claimed:

1. A method for modeling traffic management, comprising:
obtaining a dynamic model of a traffic management process;
simulating a scenario based on the traffic management process; and
measuring a resource usage of the scenario.

2. The method of claim 1, wherein the resource usage comprises a communication resource overhead.

3. The method of claim 1, wherein the method further comprises outputting feedback to a user based on dynamically evaluating alternative traffic management processes based on the resource usage of the scenario.

4. The method of claim 1, wherein the resource usage comprises a coordination overhead.

5. The method of claim 1, wherein the scenario comprises a model of an uncrewed aerial system (UAS).

6. The method of claim 1, wherein the scenario comprises a model of low-altitude air operations.

7. The method of claim 1, wherein the scenario comprises a model of short range air mobility.

8. The method of claim 1, wherein the scenario comprises a simulated event.

9. The method of claim 8, wherein the method further comprises measuring a scenario resource usage of the simulated event in the scenario.

10. The method of claim 9, wherein the simulated event comprises an emergency.

11. The method of claim 9, wherein the simulated event comprises a contingency.

12. The method of claim 1, wherein the method further comprises controlling an uncrewed aerial system based on the resource usage of the scenario.

13. The method of claim 1, further comprising evaluating the traffic management process based on the resource usage of the scenario.

14. The method of claim 1, wherein the scenario comprises a re-routing event.

15. The method of claim 1, wherein the scenario comprises a plurality of agents.

16. The method of claim 15, wherein the plurality of agents comprises a plurality of models of aerial vehicles.

17. A system for traffic management of a plurality of uncrewed aerial systems comprising:
a plurality of uncrewed aerial systems; and
a controller in operable communication with the plurality of uncrewed aerial systems, wherein the controller comprises a processor and a memory, the memory having computer-executable instructions stored thereon that, when executed by the processor, cause the processor to:
obtain a scenario, wherein the scenario comprises traffic management information for the plurality of uncrewed aerial systems;
obtain a dynamic model of a traffic management process;
simulate the scenario based on the traffic management process;
measure a resource usage of the scenario; and
control the plurality of uncrewed aerial systems based on the resource usage of the scenario.

18. The system of claim 17, wherein the memory has further computer executable instructions stored thereon that, when executed by the processor, cause the processor to:
dynamically evaluate a plurality of alternative traffic management processes based on the resource usage of the scenario.

19. The system of claim 18, wherein the system further comprises a user interface operably coupled to the controller, wherein the user interface is configured to provide feedback to a user based on dynamically evaluating the plurality of alternative traffic management processes based on the resource usage of the scenario.

20. The system of claim 17, wherein the scenario further comprises a simulated event, and wherein the memory has further computer executable instructions stored thereon that, when executed by the processor, cause the processor to: estimate a scenario resource usage of the simulated event in the scenario.
